(19) United States
(12) Patent Application Publication
(10) Pub. No.: US 2015/0269663 A1
(43) Pub. Date: Sep. 24, 2015

(54) SYSTEM AND METHOD FOR ANONYMOUSLY IDENTIFYING MEMBERS OF A SYNDICATE FOR AN INVESTMENT THEME

(71) Applicant: ASPN Solutions, LLC, New York, NY (US)

(72) Inventor: Jeffrey TARRANT, New York, NY (US)

(73) Assignee: ASPN Solutions, LLC, New York, NY (US)

(21) Appl. No.: 14/222,378

(22) Filed: Mar. 21, 2014

(51) Int. Cl. G06Q 40/00

(52) U.S. Cl. CPC G06Q 40/00

(57) ABSTRACT

A fund management system may determine an investment theme based on aggregated information related to investment research activities of a plurality of users and determine a set of potential users to include in a syndicate for the investment theme, wherein the investment theme comprises a topic on which the syndicate may base a strategy for a new investment fund. The fund management system may notify the first user of inclusion in the set of potential users of the syndicate by providing information about the syndicate; and restricting access of the first user to information related to any members of syndicate or information related to other users in the set of potential users. Responsive to the first user indicating acceptance of membership in the syndicate, the fund management system may add the first user as a member of the syndicate and provide information related to other members of syndicate.

### RELATED APPLICATIONS

This application is related to Attorney Docket No. 023113-0428155, entitled, “SYSTEM AND METHOD FOR SHARING DILIGENCE INFORMATION RELATED TO AN INVESTMENT FUND;” and Attorney Docket No. 023113-0421856, entitled, “SYSTEM AND METHOD FOR DETERMINING AN INVESTMENT THEME FOR A POTENTIAL INVESTMENT FUND,” both of which are incorporated by reference herein in their entireties.

### FIELD OF THE INVENTION

The invention relates to a system and method for determining an investment theme for a potential investment fund based on aggregated demand for information via a fund management system, determining a set of potential users for a syndicate for the potential investment fund, and notify potential users of the syndicate without providing a notified user with information related to the other potential users of the syndicate.

### BACKGROUND OF THE INVENTION

Generally speaking, a financial analyst may determine an investment theme for an investment fund based on current events, market trends, activities of other analysts and/or firms, and/or based on other criteria. An analyst may also determine an investment theme based on their personal interactions with other analysts, firms, and/or other entities.

Conventional theme determination tools may exist, but have various limitations and drawbacks. For example, an analyst may use automated tools to aggregate information related to current events, market trends, and/or other publicly available information. The analyst may be restricted to using only the proprietary information available via the analyst's firm to determine a potential investment theme. Further, the analyst may be unaware of other entities that may be interested in the same or similar investment theme. These and other drawbacks exist.

### SUMMARY OF THE INVENTION

The invention relates to a system and method for determining an investment theme for a potential investment fund based on aggregated demand for information via a fund management system, providing a recommendation as to potential individuals to include in a syndicate for the potential investment fund, and/or otherwise providing information related to a potential investment fund.

A plurality of investment firms may use the fund management system to share diligence information related to investment funds managed by the individual firms. In one example, a first firm administrator of a first firm, a first set of managers of the first firm, a first set of analysts of the first firm, a first set of clients of the first firm, a first set of third parties that work with the first firm, and/or other users associated with the first firm may access the fund management system. A firm administrator of a second firm, a second set of managers of the second firm, a second set of analysts of the second firm, a second set of clients (which may or may not overlap with the first set of clients), a second set of third parties that work with the second firm (which may or may not overlap with the first set of third parties) may also use and access the fund management system.

The fund management system may facilitate management of the research performed in relation to investment funds by various firms. That research may include the creation, editing, sharing, and/or other management of numerous documents. The documents may be, for example, documents that comprise diligence information determined for an investment fund, notes about meetings, presentations, and/or other events related to an investment fund, performance reports and/or other reports related to the execution of the investment fund, and/or other documents involved in initiating, running, and/or otherwise managing an investment fund.

Based on the investment research activities performed via the fund management system, the fund management system may determine potential investment themes for new investment funds. For a potential investment theme, the fund management system may determine a set of users to include in a syndicate that would execute an investment fund with the potential new investment theme.

The fund management system may determine a theme based on the general investment research activities of the plurality of users of the system, may determine a theme that focuses on the investment research activities of a set of users from the plurality of users, and/or may otherwise determine an investment theme. Investment research activity of a user may comprise, for example, creation of a fund, creation of a document for a fund, changing permissions for a fund, changing permissions for a document, sharing information with another user, requesting access to a document, requesting access to information about a fund, providing ratings for a fund, document, user, and/or other entity, providing feedback related to a fund, document, user, and/or other entity, identifying a mentor, receiving (and/or providing, as a mentor) ratings, feedback, and/or other information, subscribing to third party documents, and/or other activity performed via the fund management system.

In some implementations in which the investment theme is based on the general research activities of the plurality of users, the fund management system may aggregate information related to investment research activities of the plurality of users that are performed via the fund management system. Based on the aggregated information and based on information stored via the system that relate to the plurality of investment funds, the fund management system may identify a first investment theme and a first set of users to include in a syndicate for the first investment theme. The first investment theme may comprise a topic on which the syndicate may base a strategy for a new investment fund. The fund management system may reach out to the individual users included in the first set of users by providing information related to the first investment theme and an interactive user element via which the individual user may join the syndicate as a member.

In some implementations in which the investment theme is focused on the investment research activities of a set of users, the fund management system may aggregate information related to the investment research activities of the individual users of the set of users. The fund management system may then extract a set of topics from the aggregated information of the set of users. In some implementations, the set of topics may be provided to the individual users of the set of users as potential investment themes. In some implementations, the fund management system may also aggregate information related to the investment research activities of the plurality of users of the system to determine the set of potential investment themes to provide to the individual users of the set of users. The aggregated information of the set of users and the aggregated information of the plurality of users may be compared. Based on the comparison, a subset of the set of topics may be selected as the set of potential investment themes to provide to the individual users of the set of users.

In some implementations, the fund management system may determine a set of potential investment themes to provide to an individual user whereby a first investment theme may be determined with focus on the individual user and a second investment theme may be determined based on the activities of the plurality of users of the system. The investment theme(s) provided to an individual user may be marked as an individualized investment theme (e.g., having been determined with focus on the individual user), or as a general investment theme (e.g. having been determined based on the plurality of users).

The fund management system may aggregate information related to investment research activities by tracking user activity related to diligence documents of the funds, tracking requests for access to documents, tracking information related to events in which the user participated, tracking requests to share information with other users, and/or tracking other activity performed via the fund management system.

For a first user and a second user of the plurality of users, the fund management system may track the first user's activity related to a first set of diligence documents of a first fund and activity related to a second set of diligence documents of a second fund. The fund management system may also track the second user's activity related to a first set of diligence documents of a first fund and activity related to a second set of diligence documents of a second fund. The fund management system may determine a first set of tracked documents based on the tracked requests, may aggregate the information related to the first set of tracked documents, and may extract a set of document topics from the aggregated information.

While tracking user activity related to documents stored via the fund management system, the fund management system may track activity related to documents related to a same event. For example, the fund management system may track addition of a first new document to a first set of diligence documents of a first fund, where the first new document relates to a first event. The first new document may comprise a type of meeting notes, presentation notes, and/or other document type related to an event. The fund management system may also track the sharing of a second new document to the first set of diligence documents, where the second new document also relates to the first event. Based on the addition of new documents related to an event, sharing of documents related to an event, revision of documents related to an event, and/or other interaction with documents related to an event, the fund management system may aggregate information related to the first event and may extract a set of event topics from the aggregated information related to the first event.

The fund management system may also (or may alternatively) track requests for access to the first set of diligence documents by the first user and by the second user, as well as track requests for access to the second set of diligence documents by the first user and by the second user. The fund management system may determine a first set of accessed documents based on the tracked requests, may aggregate the information related to the first set of accessed documents, and may extract a set of shared topics from the aggregated information.

The fund management system may also (or may alternatively) monitor documents that are shared between the first user and by the second user. The fund management system may determine a first set of shared documents based on the monitored shared documents and may aggregate the information related to the first set of shared documents.

The fund management system may then determine a set of topics as a set of potential investment themes. The fund management system may determine a set of documents from which a set of document topics may be extracted. The set of documents may be determined from the first set of tracked documents, the first set of accessed documents, the first set of shared documents, and/or other documents of the fund management system. The set of topics may include the set of document topics, the set of event topics, the set of shared topics—and/or other topics determined by the fund management system.

The fund management system may determine scores for the individual topics in the set of topics. A score for an individual topic may be based on a score determined by the fund management system for a document associated with the topic, based on a rank of a user associated with the topic, and/or otherwise determined. In some implementations, a score for a document may be determined based on a set of factors related to a fund associated with the document, the document itself, and/or other entity associated with the document. The score for a document may be determined based on the applications of a set of weights to a respective set of factors. The set of weights may be determined by the system, received from a user, and/or otherwise obtained. In some implementations, a score for a topic may be determined based on a set of factors related to a source of the topic (e.g., a document, investment research activity, and/or other source), the topic itself, and/or other information related to the topic. The score for a topic may be determined based on the applications of a set of weights to a respective set of factors. The set of weights may be determined by the system, received from a user, and/or otherwise obtained.

The fund management system may select an investment theme from the set of potential investment themes. In some implementations, the fund management system may select the investment theme based on the scores for the individual topics.

The fund management system may also determine a set of users to include in a syndicate for an investment fund related to the determined investment theme. Responsive to the set of users comprising a first user, the fund management system may provide information related to the investment theme to the first user. The fund management system may also provide interactive user elements via which the first user may indicate interest in joining a syndicate related to the investment theme. Responsive to the fund management system receiving an indication from the first user of interest to join a syndicate related to the investment theme, the first user may be added to the syndicate as a member and may receive information about the syndicate, about the other members of the syndicate, and/or other information related to the investment theme. Responsive to the first user joining the syndicate as a member, the fund management system may provide a bonus and/or other recognition to the first user.

In some implementations in which the investment theme is focused on a set of users, the fund management system may include that set of users in the syndicate. The fund management system may also include other users in the syndicate based on the investment research activity, rankings, ratings of associated documents, and/or other information related to the other users.

In some implementations in which the investment theme is based on the investment research activities of the plurality of users, the fund management system may determine the set of users based on the investment research activity, rankings, ratings of associated documents, and/or other information related to individual users of the plurality of users.

The fund management system may determine the set of users to include in the syndicate by determining a first set of authors related to a set of documents from which the investment theme was extracted as a topic, determining a first set of managers associated with investment funds that include an individual document of the set of documents, and/or determining other users related to the investment theme. The fund management system may select the set of users to include in the syndicate from the first set of authors, first set of managers, and/or other related users.

For example, the fund management system may consider the rankings of the individual authors of the set of authors, the rankings of the individual managers of the first set of managers, and the rankings of the individual users of the other related users when selecting the set of users. The fund management system may select a predetermined number of users with the highest rankings, a predetermined number of users of particular user roles with the highest rankings, and/or other set of users based on the rankings.

The fund management system may also (and/or alternatively) select the set of users based on individual user's association with documents that impact the determination of the investment theme. For example, the fund management system may determine an impact of a first document related to a first author of the set of authors, an impact of a second document related to a second author of the set of authors, and/or other impacts of other documents considered in determining the investment theme. The fund management system may select a predetermined number of users associated with the highest impact document(s) as the set of users.

In some implementations, the fund management system may also include users in the set of users that may not be associated with a document or fund that comprises the investment theme. For example, the fund management system may access information related to the rankings of the plurality of users. The fund management system may determine a predetermined number of the plurality of users with the highest rank as a subset of high performing users. For each individual high performing user, the fund management system may determine a set of topics associated with the high performing user (e.g., by extracting the set of topics from the documents associated with the user). The fund management system may determine a relevancy of the individual topics of the set of topics to the investment theme.

The fund management system may select one or more users of the subset of high performing users based on the relevancy of the individual topics of those one or more users. For example, responsive to a determination that the relevancy of an individual topic of the set of topics for a high performing user is greater than a threshold, the high performing user may be selected. In another example, a predetermined number of high performing users associated with topics of the highest relevancy may be selected.

In some implementations, the fund management system may comprise, for example, fund management server, a non-transitory electronic storage device that may be communicably coupled to the fund management server, one or more client devices, a network via which the fund management server, storage device, and client devices may communicate, and/or other computing devices of the system.

The fund management server may include a physical processor configured to execute computer readable instructions to implement one or more system components. In some implementations, the server may comprise a non-transitory, tangible computer-readable storage medium with an executable program stored thereon, wherein the program instructs a microprocessor to perform some or all of the functionality of the plurality of system components. The system components may include, for example, a fund management component, a research management component, a theme determination component, a syndicate generation component, a role-based permissions component, and/or other components. The research management component may be configured to manage research activities related to a plurality of investment funds, including, for example, facilitating creation of an investment fund and managing investment research conducted by users related to the investment fund. The theme determination component may be configured to determine potential investment themes based on the investment research activity performed via the fund management system, and/or perform other functionality related to investment themes. The syndicate generation component may be configured to determine a set of users to include in a syndicate related to an individual investment theme, and/or perform other functionality related to the syndicate. The role-based permissions component may be configured to tailor access to the system, to a fund, to documents in the fund, and/or other access to the system based on one or more roles associated with a user of the system.

In some implementations, the theme determination component may comprise, for example, a document aggregation component, an activity monitoring component, a performance monitoring component, a theme selection component, and/or other system components. The document aggregation component may be configured to aggregate information related to documents stored at the system, and/or otherwise perform functionality related to aggregating information stored at the system. The activity monitoring component may be configured to track investment research activity performed via the system, and/or otherwise monitor activity performed via the system. The performance monitoring component may be configured to monitor performance of a user, fund, and/or other entity of the fund management system. The theme selection component may be configured to select a set of investment themes based on the aggregated information from the document aggregation component, the monitored activity from the activity monitoring component, the performance information maintained by the performance monitoring component, and/or other investment research activity performed via the fund management system.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a block diagram of an exemplary system for determining an investment theme, according to various implementations of the invention.

FIG. 2 illustrates a block diagram of an exemplary theme determination system component, according to various implementations of the invention.

FIG. 3 illustrates an exemplary process of determining an investment theme, according to various implementations of the invention.

FIG. 4 illustrates an exemplary process of aggregating information from a plurality of documents related to a plurality of funds managed by the fund management system 10, according to various implementations of the invention.

FIG. 5 illustrates an exemplary process of monitoring event activity via the fund management system 10, according to various implementations of the invention.

FIG. 6 illustrates an exemplary process of monitoring sharing activity via the fund management system 10, according to various implementations of the invention.

FIG. 7 illustrates an exemplary process of tracking requests for information via the fund management system 10, according to various implementations of the invention.

FIG. 8 illustrates an exemplary process of sending syndicate information to a user via the fund management system 10, according to various implementations of the invention.

FIG. 9 illustrates an exemplary process of determining an investment theme via the fund management system 10, according to various implementations of the invention.

FIG. 10 illustrates an exemplary process of determining a syndicate for an investment fund based on a determined investment theme via the fund management system 10, according to various implementations of the invention.

### DETAILED DESCRIPTION

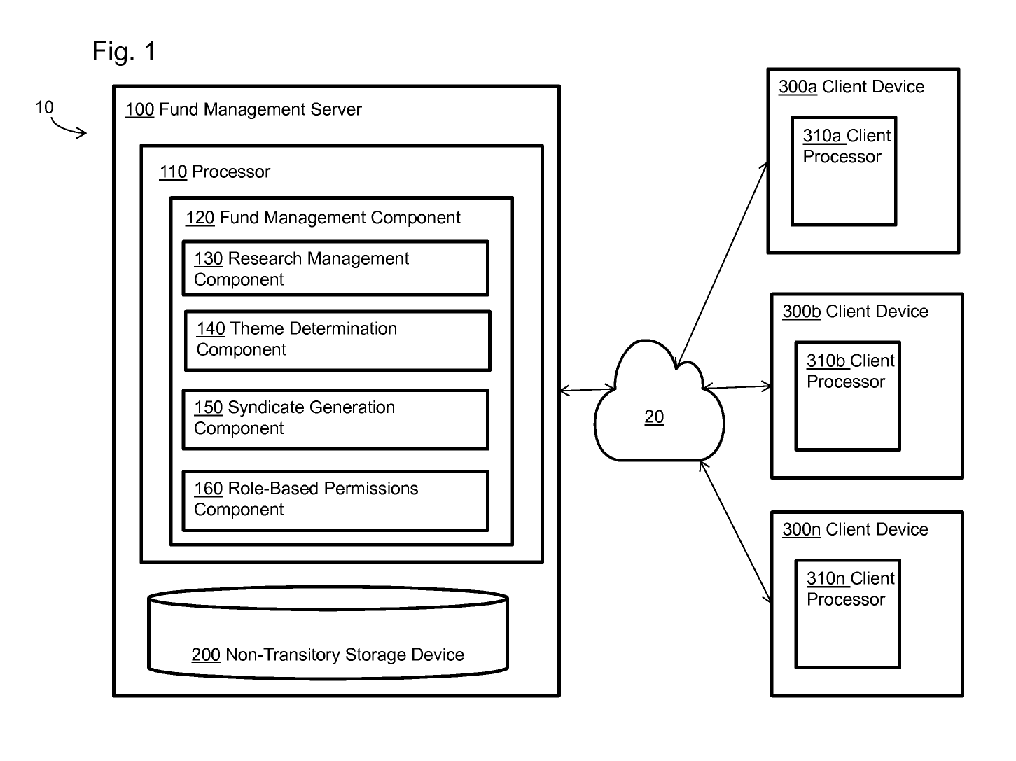

FIG. 1 illustrates an exemplary diagram of a fund management system 10 for sharing diligence information and determining an investment theme for an investment fund, according to an implementation of the invention. A plurality of investment firms may use the fund management system 10 to share diligence information related to investment funds managed by the individual firms. In one example, a first firm administrator of a first firm, a first set of managers of the first firm, a first set of analysts of the first firm, a first set of clients of the first firm, a first set of third parties that work with the first firm, and/or other users associated with the first firm may access the fund management system 10. A firm administrator of a second firm, a second set of managers of the second firm, a second set of analysts of the second firm, a second set of clients (which may or may not overlap with the first set of clients), a second set of third parties that work with the second firm (which may or may not overlap with the first set of third parties) may also use and access the fund management system 10.

The fund management system 10 may facilitate management of the research performed in relation to investment funds by various firms. That research may include the creation, editing, sharing, and/or other management of numerous documents. The documents may be, for example, documents that comprise diligence information determined for an investment fund, notes about meetings, presentations, and/or other events related to an investment fund, performance reports and/or other reports related to the execution of the investment fund, and/or other documents involved in initiating, running, and/or otherwise managing an investment fund.

The fund management system 10 may an investment theme based on the general investment research activities of the plurality of users, may determine an investment theme that focuses on the investment research activities of a set of users from the plurality of users, and/or may otherwise determine an investment theme. Along with a potential investment theme, the fund management system 10 may determine a set of users to include in a syndicate that would execute an investment fund with the investment theme. Investment research activity of a user may comprise, for example, creation of a fund, creation of a document for a fund, changing permissions for a fund, changing permissions for a document, sharing information with another user, requesting access to a document, requesting access to information about a fund, providing ratings for a fund, document, user, and/or other entity, providing feedback related to a fund, document, user, and/or other entity, identifying a mentor, receiving (and/or providing, as a mentor) ratings, feedback, and/or other information, subscribing to third party documents, and/or other activity performed via the fund management system.

In some implementations in which the investment theme is based on the general research activities of the plurality of users, the fund management system 10 may aggregate information related to investment research activities of the plurality of users that are performed via the fund management system 10. Based on the aggregated information and based on information stored via the system that relate to the plurality of investment funds, the fund management system 10 may identify a first investment theme and a first set of users to include in a syndicate for the first investment theme. The first investment theme may comprise a topic on which the syndicate may base a strategy for a new investment fund. The fund management system 10 may reach out to the individual users included in the first set of users by providing information related to the first investment theme and an ability of the individual user to join the syndicate.

In some implementations in which the investment theme is focused on the investment research activities of a set of users, the fund management system 10 may aggregate information related to the investment research activities of the individual users of the set of users. The fund management system 10 may then extract a set of topics from the aggregated information of the set of users. In some implementations, the set of topics may be provided to the individual users of the set of users as potential investment themes. In some implementations, the fund management system 10 may also aggregate information related to the investment research activities of the plurality of users of the system to determine the set of potential investment themes to provide to the individual users of the set of users. The aggregated information of the set of users and the aggregated information of the plurality of users may be compared. Based on the comparison, a subset of the set of topics may be selected as the set of potential investment themes to provide to the individual users of the set of users.

In some implementations, the fund management system 10 may determine a set of potential investment themes to provide to an individual user whereby a first investment theme may be determined with focus on the individual user and a second investment theme may be determined based on the activities of the plurality of users of the system. The investment theme(s) provided to an individual user may be marked as an individualized investment theme (e.g., having been determined with focus on the individual user), or as a general investment theme (e.g. having been determined based on the plurality of users).

The fund management system 10 may provide information related to an investment theme for the individual user but may restrict access to information related to other users in the syndicate (whether they have been provided information about the syndicate or whether they have chosen to join the syndicate). The information provided about the investment theme and the syndicate may comprise information about the investment theme, information about a role of the individual user in the syndicate, information about the relevance of the syndicate to the user, and/or other information. Responsive to a user accepting a request to join the syndicate as a member of the syndicate, the fund management system 10 may allow the individual user access to other members in the syndicate.

The fund management system 10 may include a fund management server 100, a non-transitory electronic storage device 200 that may be communicably coupled to the fund management server 100, one or more client devices 300a, 300b, . . . , 300n, a network 20 via which the fund management server 100, storage device 200, and client devices 300a, 300b, . . . , 300n may communicate, and/or other computing devices of the system 10. An administrator of the fund management system, a firm administrator, manager, analyst, client, third party, and/or other user may access the fund management system via, for example, one or more interfaces (e.g., web pages) communicated from the fund management server 100 to a client device 300n, an application such as a mobile application executing on a client device 300n that generates the interface based on information communicated from the fund management server 100, an agent running on the fund management server 100, and/or via other interfaces.

The server 100 may include a physical processor 110 configured to execute computer readable instructions to implement one or more system components. In some implementations, the server 100 may comprise a non-transitory, tangible computer-readable storage medium with an executable program stored thereon, wherein the program instructs a microprocessor to perform some or all of the functionality of the plurality of system components. The system components may include, for example, a fund management component 120, a research management component 130, a theme determination component 140, a syndicate generation component 150, a role-based permissions component 160, and/or other components.

The fund management component 120 may be configured to manage an investment fund, including, for example, managing investment research conducted by users related to the investment fund and determining potential investment themes for new investment funds. In some implementations, the fund management component 120 may comprise, for example, a research management component 130, a theme determination component 140, and/or other system components. The research management component 130 may be configured to manage research activities related to a plurality of investment funds, including, for example, facilitating creation of an investment fund, managing investment research conducted by users related to the investment fund, and/or otherwise managing research activities related to the plurality of investment funds. The theme determination component 140 may be configured to determine potential investment themes based on the investment research activity performed via the fund management system, and/or perform other functionality related to investment themes. The syndicate generation component 150 may be configured to determine a set of users to include in a syndicate related to an individual investment theme, and/or perform other functionality related to the syndicate. The role-based permissions component 160 may be configured to tailor access to the system, to a fund, to documents in the fund, and/or other access to the system based on one or more roles associated with a user of the system.

The research management component 120 may be configured to manage research activities by users of the fund management system 10, including, for example, facilitating creation of an investment fund, managing investment research conducted by users related to the investment fund, and/or otherwise managing research activities related to an investment fund. For example, the research management component 120 may enable a user to upload diligence documents, subscribe to documents from third parties, enter performance information related to an investment fund, and/or otherwise manage investment research information related to an investment fund.

In some implementations, the research management component 130 may manage research activities by users of the fund management system 10 in a manner the same or similar as that described in related co-pending U.S. Non-Provisional patent application Ser. No. ______, entitled “System and Method for Sharing Diligence Information Related to an Investment Fund,” filed on ______, 2014, which is hereby incorporated by reference in its entirety. For example, the research management component 130 may manage research activities in a manner the same as or similar to that described in relation to the fund management component 120 described in the co-pending application.

The research management component 130 may facilitate management of the research performed in relation to investment funds by various firms. That research may include the creation, editing, sharing, and/or other management of numerous documents. The documents may be, for example, documents that comprise diligence information determined for an investment fund, notes about meetings, presentations, and/or other events related to an investment fund, performance reports and/or other reports related to the execution of the investment fund, and/or other documents involved in initiating, running, and/or otherwise managing an investment fund.

A document managed by the research management component 130 may be associated with a particular fund, as well as with author(s) of the document, manager(s) associated with the fund, an administrator of the firm managing the fund, and/or other related entities. In some implementations, a document may also be associated with a client of the fund, third parties involved in the research, performance, and/or other management of the fund, and/or other entities.

Some or all of the information in a document may be proprietary. As such, the research management component 130 may enable one or more levels of restricted access to a fund and its associated documents. For example, the research management component 130 may allow a fund manager, fund administrator, system administrator, and/or other fund-level entity to restrict access to information about funds, information about a document of a fund, and/or other information.

The research management component 130 may allow a fund-level entity to set fund permissions for a fund. The fund permissions may comprise a plurality of fund permission settings including, for example, a fund indicator, a set of document type indicators, a set of document rules, and/or other permissions related to access of the fund. The fund indicator may comprise an indication of whether any information related to the fund may be shared with entities outside of the managers, analysts, and/or other users identified with the fund. An individual document type indicator of the set of document type indicators may comprise an indication of whether a document of a corresponding document type may be shared with entities outside of the managers, analysts, and/or other users identified with the fund. An individual document rule of the set of document rules may comprise an indication of whether a particular document may be shared with entities outside of the managers, analysts, and/or other users identified with the fund. In some implementations, a document rule may also comprise a set of portion rules. An individual portion rule of the set of portion rules may comprise an indication of whether a particular portion of the document may be shared with entities outside of the managers, analysts, and/or other users identified with the fund.

In some implementations, the set of fund permissions, and/or each component of the set of fund permissions, may comprise a user list including a list of entities outside of the managers, analysts, and/or other users identified with the fund with whom information related to the fund may be shared.

Based on the set of fund permissions for a fund, entities not associated with the fund may be allowed access to information related to the fund, information related to one or more documents of the fund, and/or other related information. For example, all managers of a firm may be allowed access to information and documents of each fund associated with the firm. In another example, a client may be allowed access to certain information and documents of a fund in which they have invested.

The research management component 130 may allow an author of a document associated with a fund to share the document with an entity that is not associated with the fund via the fund management system, where that entity may have access to information about the document (based on the set of fund permissions for the fund) but may not be able to access the document itself. The research management component 130 may allow an author of a document to set author permissions for the document, whereby another level of restricted access may be provided to entities based on the author permissions.

The author permissions for a document may comprise a plurality of author permission settings including, for example, a document indicator, a set of portion rules, and/or other permissions related to access of the fund. A document indicator for a particular document may comprise an indication of whether the particular document may be shared with entities outside of the managers, analysts, and/or other users identified with the fund. An individual portion rule of the set of portion rules may comprise an indication of whether a particular portion of the document may be shared with entities outside of the managers, analysts, and/or other users identified with the fund. In some implementations, the author rule may also comprise a version rule indicating whether a document labeled as a draft version (instead of a final version) may be shared with entities outside of the managers, analysts, and/or other users identified with the fund.

In some implementations, the author permissions, and/or components of the author permissions, may also comprise a corresponding user list including a list of entities (and/or user roles) outside of the managers, analysts, and/or other users identified with the fund associated with the document with whom information related to the document may be shared.

Responsive to a determination that an author wants to share documents with another entity, the research management component 130 may send a request to the other entity with the request to share documents. Responsive to the other entity accepting the request, the research management component 130 may share the documents of the other entity with the author as well. The documents that are shared between the author and the other entity may be selected by each individual user, may be delineated by fund, may be delineated by document type, and/or may be determined based on other criteria. User list(s) associated with author permissions for the shared document(s) may be updated based on the acceptance of the request.

The research management component 130 may allow users with whom documents are shared to rate the documents. The research management component 130 may provide an author of the document with ratings, feedback, and/or other information provided by a user with whom the document was shared. The research management component 130 may aggregate ratings for documents, authors, funds, firms, and/or other entities.

The research management component 130 may also allow a user to identify one or more mentors. The research management component 130 may allow a user to share all of the documents and/or information related to funds with which the user is associated with a mentor. The research management component 130 may allow a mentor to provide ratings, feedback, and/or other information related to a user, a document, a set of documents, documents of particular document type, a fund, and/or other entity related to the user. The research management component 130 may aggregate the ratings, feedback, and/or other information provided by the one or more mentors.

In some implementations, the research management component 130 may be configured to manage an investment fund, including, for example, facilitating creation of an investment fund and managing investment research conducted by users related to the investment fund. For example, the research management component 130 may be configured to facilitate creation of a fund in the system, allow a user to provide fund permissions for the fund, and/or otherwise perform functionality related to creating an investment fund. The research management component 130 may also be configured to allow a user to upload a document for an investment fund, provide author permissions for the document, and/or otherwise manage the document. In addition, the research management component 130 may be configured to receive information related to performance of an investment fund, update performance statistics, outlooks, and/or other logistics related to performance of the investment fund, and/or otherwise manage information related to the performance of an investment fund. Further, the research management component 130 may also be configured to receive documents from third parties based on a third-party subscription, maintain subscriptions to third party information, allow a user to provide commentary on a document received from a third party, and/or otherwise manage subscriptions to third party information sources.

In some implementations, the research management component 130 may be configured to facilitate sharing of a document for an investment fund with other users of the fund management system. For example, the research management component 130 may be configured to allow a user to invite another entity to share information via the fund management system. The research management component 130 may also be configured to allow a third party to access a document of a user based on the set of fund permissions associated with the fund, based on author permissions associated with the document, and/or based on other information related to the document. The research management component 130 may further be configured to allow an entity that shares information from a user to rate documents shared by the user, rate the user, rate a fund associated with the user, and/or otherwise provide ratings related to the user, aggregate ratings related to shared documents, aggregate ratings related to users, aggregate ratings related to funds, and/or otherwise manage ratings. Additionally, the research management component 130 may be configured to allow a user to identify mentors for the user, share documents with an identified mentor, receive a rating for an individual shared document from an identified mentor, receive feedback related to the individual shared document from the identified mentor, aggregate ratings from identified mentors for a user, and/or otherwise receive and manage feedback from one or more mentors.

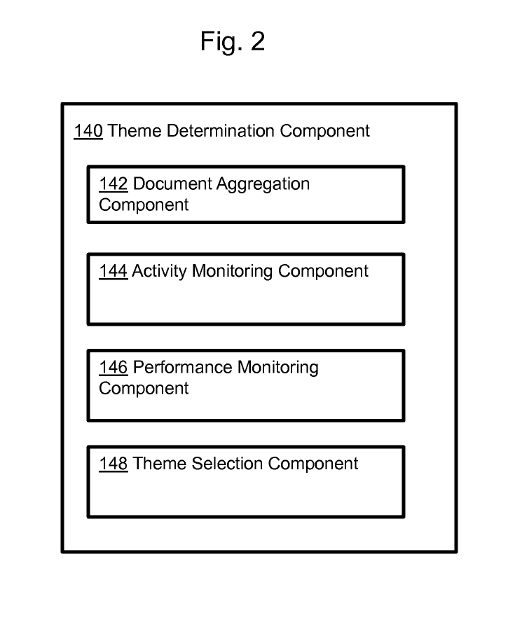

FIG. 2 illustrates a block diagram of an exemplary theme determination component 140, according to various implementations of the invention. In some implementations, the theme determination component 140 may comprise, for example, a document aggregation component 142, an activity monitoring component 144, a performance monitoring component 146, a theme selection component 148, and/or other system components.

The document aggregation component 142 may be configured to aggregate information related to documents stored at the system, and/or otherwise perform functionality related to aggregating information stored at the system. The activity monitoring component 144 may be configured to track investment research activity performed via the system, and/or otherwise monitor activity performed via the system. The performance monitoring component 146 may be configured to monitor performance of a user, fund, and/or other entity of the fund management system. The theme selection component 148 may be configured to select a set of investment themes based on the aggregated information from the document aggregation component, the monitored activity from the activity monitoring component, the performance information maintained by the performance monitoring component, and/or other investment research activity performed via the fund management system.

The document aggregation component 142 may be configured to aggregate information related to documents stored at the system, and/or otherwise perform functionality related to aggregating information stored at the system. For example, the document aggregation component 142 may aggregate information from a plurality of documents from a plurality of funds managed by the fund management system.

The document aggregation component 142 may be configured to determine a set of topics based on the aggregated information. In some implementations, the document aggregation component 142 may determine a subset of topics for each individual document and aggregate the determined subsets of topics to determine the set of topics. In some implementations, the document aggregation component 142 may aggregate the data of all of the documents and determine a set of topics from the aggregated data.

The document aggregation component 142 may determine a topic by from a document (or the aggregated data) by excluding certain types of words, and analyzing the remaining words and word groups. The types of words that may be excluded may include one or more of: words of particular parts of speech (e.g., verbs, prepositions, pronouns, interjections, and/or other parts of speech), proper nouns, names of persons, words included in a list of common words stored in the non-transitory electronic storage device 200, and/or other types of words. Other ways of determining a topic may be used as well. The ways in which a topic may be determined are not limited to the examples described herein.

For an individual topic of the set of topics, the document aggregation component 142 may determine frequency of the topic across all documents, number of documents in which the topic appeared, average rating of the documents in which the topic appeared, average rating of the authors of the documents in which the topic appeared, and/or other information related to the topic.

In some implementations, the document aggregation component 142 may receive, from a user, aggregation settings for restricting the aggregation of information from the plurality of documents. For example, the settings may comprise a set of firms from which the plurality of funds may be obtained, a set of fund types, a set of document types, a set of authors, a set of managers of funds, a time period during which a creation date, access date, revision date, and/or other date associated with a document must reside, document rating threshold, fund rating threshold, user rating threshold, user association with a mentor and/or other settings. The document aggregation component 142 may use the received settings to restrict the documents from which information is aggregated when determining potential investment themes for the user.

The activity monitoring component 144 may be configured to track investment research activity performed via the system, and/or otherwise monitor activity performed via the system.

The activity monitoring component 144 may monitor and/or aggregate information related to investment research activities. For example, the activity monitoring component 144 may monitor and/or aggregate information related to investment research activities by tracking user activity related to diligence documents of the funds, tracking requests for access to documents, tracking requests to share information with other users, tracking information related to user participation in events, and/or tracking other activity performed via the fund management system.

For example, for a first user and a second user of the plurality of users, the activity monitoring component 144 may track the first user's activity related to a first set of diligence documents of a first fund and activity related to a second set of diligence documents of a second fund. The activity monitoring component 144 may also track the second user's activity related to a first set of diligence documents of a first fund and activity related to a second set of diligence documents of a second fund. The activity monitoring component 144 may determine a first set of tracked documents based on the tracked requests and may aggregate the information related to the first set of tracked documents.

While tracking user activity related to documents stored via the fund management system, the activity monitoring component 144 may track activity related to documents related to user participation in a same event. For example, the activity monitoring component 144 may track addition of a first new document to a first set of diligence documents of a first fund, where the first new document relates to a first event. The first new document may comprise a type of meeting notes, presentation notes, and/or other document type related to an event. The activity monitoring component 144 may also track the sharing of a second new document to the first set of diligence documents, where the second new document also relates to the first event. Based on the addition of new documents related to an event, sharing of documents related to the event, revision of documents related to the event, and/or other interaction with documents related to the event, the activity monitoring component 144 may aggregate information related to the first event and may extract a set of event topics from the aggregated information related to the first event.

The activity monitoring component 144 may also track whether events are related, may aggregate information related to related events, and may extract a set of event topics from the aggregated information related to the related events. The activity monitoring component 144 may determine whether a first event and a second event are related based on a similarity of topics extracted from the documents related to the first event and the topics extracted from the documents related to the second event. The activity monitoring component 144 may also determine whether a first event and a second event are related based on a similarity in the attendees of the events, chronology of the events, and/or other characteristics of the events.

The activity monitoring component 144 may also (or may alternatively) track requests for access to the first set of diligence documents by the first user and by the second user, as well as track requests for access to the second set of diligence documents by the first user and by the second user. The activity monitoring component 144 may determine a first set of accessed documents based on the tracked requests and may aggregate the information related to the first set of accessed documents.

The activity monitoring component 144 may also (or may alternatively) track the sharing of information from a first user to a second user via the fund management system 10. The activity monitoring component 144 may determine a first set of shared documents based on the documents shared between users and may aggregate the information related to the first set of shared documents.

The activity monitoring component 144 may determine a topic by from the aggregated information in a manner similar to document aggregation component 142. In some implementations, the activity monitoring component 144 may determine different sets of topics for different activities. For example, for each individual type of activity (e.g., creating a document, sharing information, requesting access to a document, participating in an event, and/or other activity), the activity monitoring component 144 may determine a separate set of topics. In some implementations, the activity monitoring component 144 may aggregate the separate sets of topics into a set of activity topics. In some implementations, the activity monitoring component 144 may not aggregate the separate sets of topics.

For an individual topic of a set of topics, the activity monitoring component 144 may determine frequency of the topic across the tracked activities, number of types of tracked activities associated with the topic, number of users involved in the activity, number of times activity in which topic occurred was performed, average rating of the documents related an activity in which the topic appeared, average rating of the users involved in the activity, and/or other information related to the topic.

In some implementations, the activity monitoring component 144 may receive, from a user, activity settings for restricting the aggregation of information from the investment research activity. For example, the settings may comprise a set of firms implicated in the activity, a set of fund types implicated in the activity, a set of document types of documents implicated in the activity, a set of authors involved in the activity, a set of managers involved in the activity, a time period during which the activity must occur or creation, access, revision, and/or other action for a document related to the activity must occur, document rating threshold of documents implicated in the activity, fund rating threshold of funds implicated in the activity, user rating threshold of users involved in the activity, user association with a mentor of users involved in the activity, and/or other settings. The activity monitoring component 144 may use the received settings to restrict the investment research activity from which information is aggregated when determining potential investment themes for the user.

The performance monitoring component 146 may be configured to monitor performance of funds, users, and/or other entities and provide a score for a topic based on associated performance information.

The performance monitoring component 146 may also be configured to receive information related to performance of an investment fund, update performance statistics, outlooks, and/or other logistics related to performance of the investment fund, and/or otherwise update information related to the performance of an investment fund. The performance monitoring component 146 may receive information related to the performance of the fund from a user of the system (e.g., a manager, analyst, and/or other user involved in managing the fund), may obtain updated performance information by crawling the internet for information related to performance of the fund, may determine performance information based on documents received from a user, via subscription, and/or otherwise received, and/or may otherwise obtain information related to performance of a fund.

The performance monitoring component 146 may store a set of statistics and/or other performance information related to the user, fund, and/or other entity in the non-transitory electronic storage device 300. The performance monitoring component 146 may update the set of statistics and/or other performance information responsive to obtaining updated performance information for the user, fund, and/or other entity. For example, the performance monitoring component 146 may prepare a document comprising performance information for a user, for a fund, and/or for another entity.

The performance monitoring component 146 may be configured to rank a set of firms, set of funds, set of users, and/or other entities based on performance information associated with the entities. In some implementations, the performance monitoring component 146 may provide a score for an individual set of topics based on the performance associated with a fund, user(s), and/or other entity associated with the topic. For example, the performance monitoring component 146 may be configured to prepare a set of scored topics based on a set of topics (e.g., the set of document topics, the set of activity topics, and/or other set of topics).

In some implementations, the performance monitoring component 146 may receive, from a user, performance settings for restricting the application of performance information to a topic. For example, the settings may comprise a set of firms, a set of funds, a set of document types of documents, a set of analysts, a set of managers, a time period during which documents and/or activities associated with the topic must occur, document rating threshold of documents associated with the topic, fund rating threshold of funds associated with the topic, user rating threshold of users associated with the topic, user association with a mentor of users associated with the topic, and/or other settings. The performance monitoring component 146 may use the received settings to restrict the performance information used to score a topic.

The theme selection component 148 may be configured to select a set of investment themes based on the aggregated information from the document aggregation component, the monitored activity from the activity monitoring component, and/or other information available via the fund management system.

The theme selection component 148 may determine a set of topics as a set of potential investment themes. In some implementations, the theme selection component 148 may aggregate the set of document topics, the set of activity topics, and/or other topics determined by the fund management system 10 and determine the of potential investment themes from the aggregated set. In some implementations, the theme selection component 148 may select a subset of the set of potential investment themes from the set of document topics, a subset of the set of potential investment themes from the set of activity topics, and/or a subset of the set of potential investment themes from other sets of topics determined by the fund management system 10. In some implementations, the topics used by the theme selection component 148 to determine the set of potential investment themes may be topics for which scores were prepared by the performance monitoring component 146.

The theme selection component 148 may determine a score for an individual topic based on a set of factors, a set of weights for the factors, one or more scores of respective one or more documents comprising the topic, and/or other information related to the topic.

In some implementations, a score for a document may be determined based on a set of factors associated with the document, a set of weights for the factors, and/or other information. The score for a document may be determined based on the applications of the set of weights to the respective set of factors. The factors may comprise, for example, fund identification, whether the document is related to an event, whether the document has been shared, and/or other factors related to a document. The set of weights may be determined by the system, received from a user, and/or otherwise obtained.

In some implementations in which the performance monitoring component 146 prepared a score for a topic, the theme selection module 148 may not prepare a further score, may use the prepared score as another factor to consider when determining the score for the topic, may weigh the prepared score and the scored determined from the application of the set of weights to the respective set of factors proportionally, may ignore the prepared score, and/or may otherwise handle the prepared score while determining a score for the topic.

The set of factors and set of weights for a topic may differ depending on the source of the topic (e.g., document, investment research activity, and/or other source). The set of factors may comprise one or more characteristics of the topic for which values may be obtained. The set of weights may comprise one or more weights, such that an individual weight is to be applied to an individual factor. The theme selection component 148 may determine a score for a document type by applying individual weights to individual values of the individual factors.

The factors may be stored in the non-transitory electronic storage device 200, pre-set by the system 10, received from a system administrator, received from a firm administrator, received from a user, and/or otherwise obtained. The weights may be stored in the non-transitory electronic storage device 200, pre-set by the system 10, received from a system administrator, received from a firm administrator, received from a user, and/or otherwise obtained.

In some examples, for a topic extracted from a document, the factors may comprise frequency of the topic, document type, recency, document ranking, author ranking, and/or other factors related to documents. In some examples, for a topic extracted from an event, the factors may comprise frequency of the topic, event type, document type, recency, number of attendees, number of related events, and/or other factors related to monitoring events. In some examples, for a topic extracted from a shared document, the factors may comprise frequency of the topic, fund identification, manager identification, document type, recency, number of shares for document, and/or other factors related to monitoring shared information. In some examples, for a topic extracted from tracked requests for documents, the factors may comprise frequency of the topic, fund identification, manager identification, document type, recency, number of requests for document, number of requests per user, and/or other factors related to tracking requests for access to documents.

In some implementations, the theme selection component 148 may be configured to facilitate individually customized scoring of the topics. For example, the theme selection component 148 may be configured to receive the factors to consider for topics of a particular source, the weights to apply to the factors that are considered, both the factors and the weights for topics of a particular source, and/or other information related to determining a score for a topic. The theme selection component 148 may be configured to facilitate firm-customized scoring, fund-customized scoring, customized scoring for a predetermined group of users, and/or other types of customized scoring.

The theme selection component 148 may store the scored scores for a topic in association with the topic in the non-transitory electronic storage device 200 as a scored topic.

The theme selection component 148 may select an investment theme from the set of scored topics. In some implementations, the theme selection component 148 may rank the scored topics and select the highest ranked topic as the investment theme. In some implementations, the theme selection component 148 may determine which scored topics have already been provided to a user and may provide the highest ranked scored topic which has not yet been provided to the user. In some implementations, the theme selection component 148 may select an investment theme based on user preferences for the user that are stored in the non-transitory electronic storage media. The ways in which the theme selection component 148 select an investment theme are not limited to the examples described herein. In some implementations, the theme selection component 148 may select a predetermined-number of scored topics as a set of investment themes to provide to the user in a manner similar to selecting an individual scored topic.

In some implementations, the theme selection component 148 may provide an investment theme to the user regardless of whether the user is included in a syndicate related to the investment theme. In these implementations, the theme selection component 148 may provide information related to the syndicate, including, for example, members of the syndicate, whether a user has accepted a request to join the syndicate, and/or other information related to the syndicate. In some implementations, the theme selection component 148 may not provide information related to the syndicate, may provide an interactive user element via which the user may request to join a syndicate related to the investment theme, and/or may provide other information related to the investment theme.

In some implementations, the theme selection component 148 may only provide the investment theme to the user responsive to a determination that the user is included in the syndicate. In these implementations, the theme selection component 148 may provide information related to the syndicate, including, for example, members of the syndicate, whether a user has accepted a request to join the syndicate, and/or other information related to the syndicate. In some of these implementations, the theme selection component 148 may not provide information related to whether a user has accepted a request to join the syndicate.

Returning to FIG. 1, the syndicate generation component 150 may be configured to determine a set of users to include in a syndicate related to an individual investment theme, and/or perform other functionality related to the syndicate.

The syndicate generation component 150 may determine a set of users to include in a syndicate for an investment fund related to the determined investment theme. For each individual user included in the syndicate, the syndicate generation component 150 may provide information related to the investment theme. The syndicate generation component 150 may also provide interactive user elements via which the individual users may indicate interest in joining a syndicate related to the investment theme. Responsive to the syndicate generation component 150 receiving an indication from an individual user of interest to join the syndicate related to the investment theme, the individual user may be added to the syndicate as a member of the syndicate and may receive information about the syndicate, about the other members of the syndicate, and/or other information related to the investment theme.

The syndicate generation component 150 may provide information to an individual user before the user indicates interest to join the syndicate. The syndicate generation component 150 may, however, restrict access to information about the other potential users of the syndicate and the members of the syndicate. As such, the syndicate generation component 150 may anonymously identify users of the syndicate. The information provided to the individual user may comprise information about the investment theme, information related to a role of the individual user in the syndicate, an impact of the individual user in determining the investment theme for the syndicate, relevance of the investment theme of the syndicate to the individual user, an invitation to join the syndicate, and/or other information related to the individual user and the syndicate.

In an implementation, syndicate generation component 150 may provide an alert to employees of an entity that operates the system (e.g., users other than users to whom the information related to the syndicate is provided) that a potential syndicate has been generated. The alert may include an indication that syndicate generation component 150 will provide or has provided individual users with the information related to the syndicate. In an implementation, the alert may not identify any one of the individual users to whom the information will be provided or has been provided. In this manner, the individual users are anonymized with respect to the employees of the entity as well.

In an implementation, syndicate generation component 150 may wait to provide the information related to the syndicated to individual users until an employee of the entity approves the syndicate. For example, responsive to receiving an alert regarding a potential syndicate, an employee of the entity that operates the system may review the potential syndicate and approve or disapprove of the potential syndicate. Upon receipt of an approval, syndicate generation component 150 may provide the information to the individual users.

Responsive to the user accepting an invitation to join the syndicate or otherwise adding the user as a member of the syndicate, the syndicate generation component 150 may allow the member to access information related to the other members of the syndicate. In some implementations, the syndicate generation component 150 may allow the member to access information related to other potential users to be included in the syndicate as well.

In some implementations in which the investment theme is focused on a set of users, the syndicate generation component 150 may include that set of users in the syndicate. The syndicate generation component 150 may also include other users in the syndicate based on the investment research activity of the other users of the system 10, rankings for the other users, ratings of associated documents, and/or other information related to the other users.

In some implementations in which the investment theme is based on the investment research activities of the plurality of users, the syndicate generation component 150 may determine the set of users based on the investment research activity of the plurality of users of the system 10, rankings for the plurality of users, ratings of associated documents, and/or other information related to individual users of the plurality of users.

The syndicate generation component 150 may determine the set of users to include in the syndicate by determining a first set of authors related to a set of documents from which the investment theme was extracted as a topic, determining a first set of managers associated with investment funds that include an individual document of the set of documents, and/or determining other users related to the investment theme. The syndicate generation component 150 may select the set of users to include in the syndicate from the first set of authors, first set of managers, and/or other related users.

For example, the syndicate generation component 150 may consider the rankings of the individual authors of the set of authors, the rankings of the individual managers of the first set of managers, and/or the rankings of the individual users of the other related users when selecting the set of users. The syndicate generation component 150 may select a predetermined number of users with the highest rankings, a predetermined number of users of particular user roles with the highest rankings, and/or other set of users based on the rankings.

The syndicate generation component 150 may also (and/or alternatively) select the set of users based on individual user's association with documents that impact the determination of the investment theme. For example, the syndicate generation component 150 may determine an impact of a first set of documents related to a first author of the set of authors, an impact of a second set of documents related to a second author of the set of authors, and/or impacts of other sets of documents considered in determining the investment theme. An impact of a set of documents associated with a user may be determined, for example, based on a number of documents in the set of documents, a number of occurrences of the topic in the set of documents, a score of the investment theme based only on the set of documents, an average score of the documents in the set of documents, any combination thereof, and/or other criteria. The syndicate generation component 150 may select a predetermined number of users associated with the highest impact document(s) as the set of users.

In some implementations, the syndicate generation component 150 may determine an impact of a set of documents and a set of funds related to a user in determining the investment theme and may include the user as a potential user in the syndicate responsive to the impact being greater than a predetermined threshold. In some implementations, the syndicate generation component 150 may also include users in the set of users that may not be associated with a document or fund that comprise the investment theme.

For example, the syndicate generation component 150 may access information related to the rankings of the plurality of users. The syndicate generation component 150 may determine a predetermined number of the plurality of users with the highest rank as a subset of high performing users. For each individual high performing user, the syndicate generation component 150 may determine a set of topics associated with the high performing user (e.g., by extracting the set of topics from the documents associated with the user). The syndicate generation component 150 may determine a relevancy of the individual topics of the set of topics to the investment theme. The syndicate generation component 150 may select one or more users of the subset of high performing users based on the relevancy of the individual topics of those one or more users. For example, responsive to a determination that the relevancy of an individual topic of the set of topics for a high performing user is greater than a threshold, the high performing user may be selected. In another example, a predetermined number of high performing users associated with topics of the highest relevancy may be selected. In another example, the syndicate generation component 150 may select a user based on a number of topics associated with the user being greater than a predetermined threshold number.

In another example, the syndicate generation component 150 may be configured to receive information related to performance of a user of the fund management system 10. The performance information received and/or maintained for a user by the syndicate generation component 150 may depend upon the user role associated with the user. For example, a user with a role of manager may be associated with different performance information than a user with a role of analyst. The performance information monitored by the syndicate generation component 150 for a user may comprise, for example, rating by peers, ratings by mentors, feedback by peers, feedback by mentors, negotiation skills, number of associated funds, number of documents authored, number of relationships, number of shared documents, percentage of inclusion of best-of-breed terms in associated investment funds, percentage of high-performing funds, percentage of syndicates joined based on provided investment themes, and/or other performance information. The syndicate generation component 150 may select an individual user to include in the syndicate based on the performance information for that user. For example, the syndicate generation component 150 may compare performance information for a plurality of users and may select a predetermined number of users with the best performance information to include in the syndicate.

In another example, the syndicate generation component 150 may access information relating to a predetermined number of the highest rankings users of the system. The syndicate generation component 150 may determine a subset of the highest ranking users to include in the set of potential users in the syndicate. For example, the syndicate generation component 150 may determine the subset by determining a list of topics associated with the highest ranking users, determining a relevancy of the list of topics to the investment theme, and determining a relevancy of the topics associated with each individual user to the investment theme. The syndicate generation component 150 may include those high ranking users with an associated relevancy as being greater than a predetermined threshold as potential users in the syndicate.

In some implementations, responsive to the first user joining the syndicate, the syndicate generation component 150 may provide a bonus and/or other recognition to the first user. In some implementations, the syndicate generation component 150 may provide a bonus and/or other recognition to a member of the syndicate based on performance information related to the user, based on the user being a high-performing user, based on the user being associated with an amount of documents and investment research activity beyond a threshold amount, based on the user recommending the investment theme via the system 10, and/or based on other criteria. The performance information may comprise an indication that the related to a fee class of the syndicate, an indication that the user has strong negotiation skills, and/or other performance information. The bonus and/or other recognition provided to the user may comprise, for example, a better fee class for the syndicate, a contribution to a charity of their choice, a monetary grant to a client, a research grant for an endowment, a monetary gift, and/or other recognition.

The role-based permissions component 160 may be configured to tailor access to the system, to a fund, to documents in the fund, and/or other access to the system based on one or more roles associated with a user of the system.

The role-based permission component 160 may be configured to tailor access to the system based on roles of various users including, for example, a role in the system, a role in a fund, and/or other roles. The one or more roles may include system-level roles, fund-level roles, and/or other types of roles. System-level roles may grant access to various system features such as for example, access to one or more components, access to content stored at a storage component, and/or other access to system features. System-level roles may be configured, for example, to manage storage of information in the non-transitory electronic storage device 200, access to funds, access to documents, access to ratings, access to feedback, access to scales for ratings, access to attributes for entities, and/or other system-level features. Different system-level roles may be granted that provide access to different system features. Fun-level roles may grant access to various features related to funds such as, for example, access to the content of the fund, access to information of users of the fund, access to ratings and/or feedback related to the fund, and/or other access. Different fund-based roles may be granted that provide access to different fund features. The role-based permissions component 160 may maintain a plurality of roles, including, for example, administrator of the fund management system, firm administrator, manager, analyst, third party, and/or other roles.

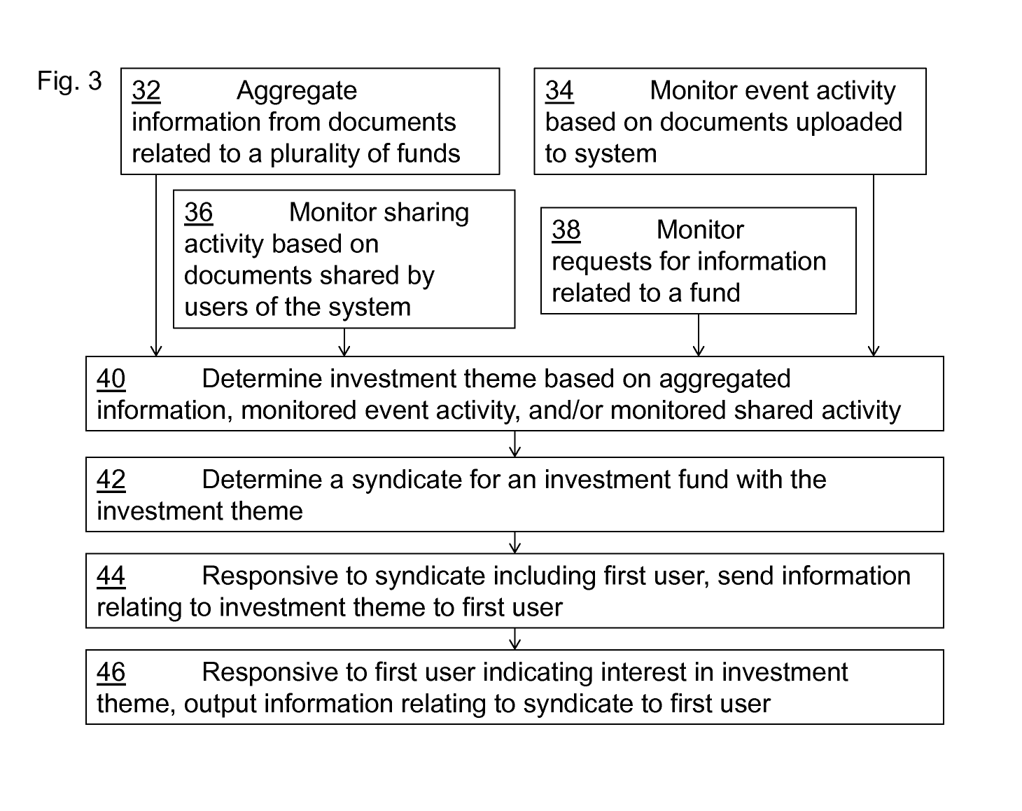

FIG. 3 illustrates an exemplary process of determining an investment theme, according to various implementations of the invention.

The described operations of FIG. 3 and other figures may be accomplished using some or all of the system components described in detail above and, in some implementations, various operations may be performed in different sequences. In other implementations, additional operations may be performed along with some or all of the operations shown in FIG. 3 and the other figures. In yet other implementations, one or more operations may be performed simultaneously. In yet other implementations, one or more combinations of various operations may be performed. Some implementations may not perform all of the operations described with relation to FIG. 3 and other figures. Accordingly, the operations described are exemplary in nature and, as such, should not be viewed as limiting.

In some embodiments, the operations described in FIG. 3 and the other figures may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations described in FIG. 3 and the other figures in response to instructions stored electronically on an electronic storage medium. The one or more processing devices may include one or more devices configured through hardware, firmware, and/or software to be specifically designed for execution of one or more of the operations described in FIG. 3 and the other figures.

In an operation 32, the fund management system 10 may aggregate information from a plurality of documents from a plurality of funds managed by the fund management system. The theme determination component 140 may aggregate the information from the plurality of documents in a manner the same or similar as that described above.

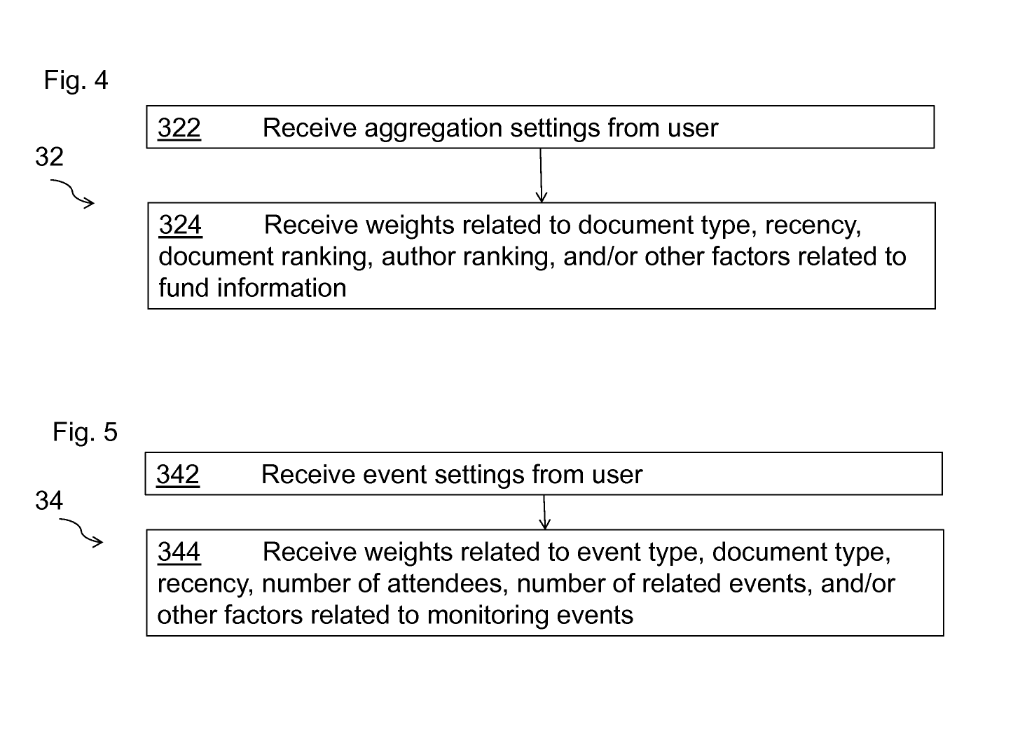

For example, FIG. 4 illustrates an exemplary process of aggregating information from a plurality of documents related to a plurality of funds managed by the fund management system 10, according to various implementations of the invention.

In an operation 322, the fund management system 10 may receive from the first user aggregation settings for aggregating the information from the plurality of documents. The theme determination component 140 may allow the first user to set the aggregation settings in a manner the same or similar as that described above.

In an operation 324, the fund management system 10 may receive weights from the first user, where the weights may relate to document type, recency, and/or other factors. The theme determination component 140 may receive the weights in a manner the same or similar as that described above.

Returning to FIG. 3, in an operation 34, the fund management system 10 may monitor event activity related investment research activities based on documents uploaded to the fund management system 10. The theme determination component 140 may monitor event activity in a manner the same or similar as that described above.

For example, FIG. 5 illustrates an exemplary process of monitoring event activity via the fund management system 10, according to various implementations of the invention.

In an operation 342, the fund management system 10 may receive from the first user event settings for monitoring event activity. The theme determination component 140 may allow the first user to set the event settings in a manner the same or similar as that described above.

In an operation 344, the fund management system 10 may receive weights from the first user, where the weights may relate to event type, document type, recency, number of attendees, number of related events, and/or other factors. The theme determination component 140 may receive the weights in a manner the same or similar as that described above.

Returning to FIG. 3, in an operation 36, the fund management system 10 may monitor sharing activity based on documents shared by users of the fund management system 10. The theme determination component 140 may monitor sharing activity in a manner the same or similar as that described above.

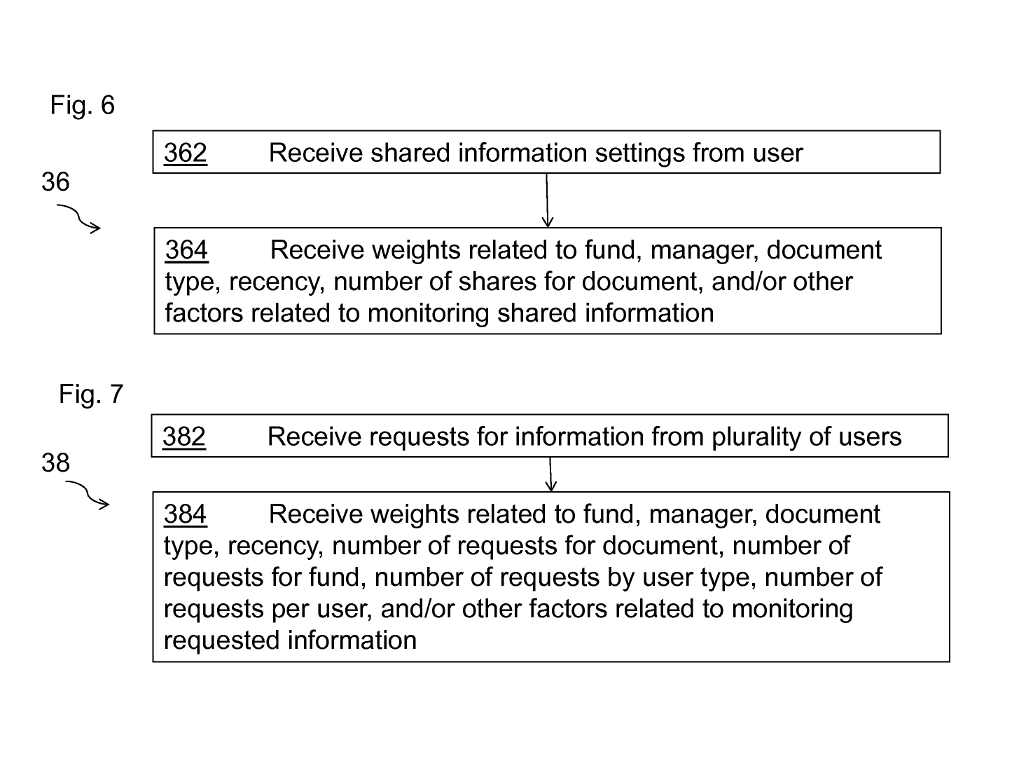

For example, FIG. 6 illustrates an exemplary process of monitoring sharing activity via the fund management system 10, according to various implementations of the invention.

In an operation 362, the fund management system 10 may receive from the first user shared information settings for monitoring shared activity via the fund management system 10. The theme determination component 140 may allow the first user to set the shared information settings in a manner the same or similar as that described above.

In an operation 364, the fund management system 10 may receive weights from the first user, where the weights may relate to fund, manager, document type, recency, number of shares per documents, and/or other factors. The theme determination component 140 may receive the weights in a manner the same or similar as that described above.

Returning to FIG. 3, in an operation 38, the fund management system 10 may track requests for information related to funds managed by the fund management system 10. The theme determination component 140 may track requests for information in a manner the same or similar as that described above.

FIG. 4 illustrates an exemplary process of aggregating information from a plurality of documents related to a plurality of funds managed by the fund management system 10, according to various implementations of the invention. FIG. 5 illustrates an exemplary process of monitoring event activity via the fund management system 10, according to various implementations of the invention. FIG. 6 illustrates an exemplary process of monitoring sharing activity via the fund management system 10, according to various implementations of the invention. FIG. 7 illustrates an exemplary process of tracking requests for information via the fund management system 10, according to various implementations of the invention.

For example, FIG. 7 illustrates an exemplary process of tracking requests for information via the fund management system 10, according to various implementations of the invention.

In an operation 382, the fund management system 10 may receive requests for information from a plurality of users. The theme determination component 140 may receive requests for information in a manner the same or similar as that described above.

In an operation 384, the fund management system 10 may receive weights from the first user, where the weights may relate to fund, manager, document type, recency, number of requests per documents, number of requests per fund, number of requests by user type, number of requests per user, and/or other factors. The theme determination component 140 may receive the weights in a manner the same or similar as that described above.

Returning to FIG. 3, in an operation 40, the fund management system 10 may determine an investment theme based on the aggregated information, monitored event activity, monitored shared activity, and/or other information. The theme determination component 140 may determine the investment theme in a manner the same or similar as that described above.

In an operation 42, the fund management system 10 may determine a syndicate comprising a set of users well suited to execute an investment fund with the determined investment theme. The theme determination component 140 may determine the syndicate in a manner the same or similar as that described above.

In an operation 44, the fund management system 10 may output information related to the syndicate to a first user of the set of users responsive to the syndicate including the first user. The theme determination component 140 may determine the investment theme in a manner the same or similar as that described above.

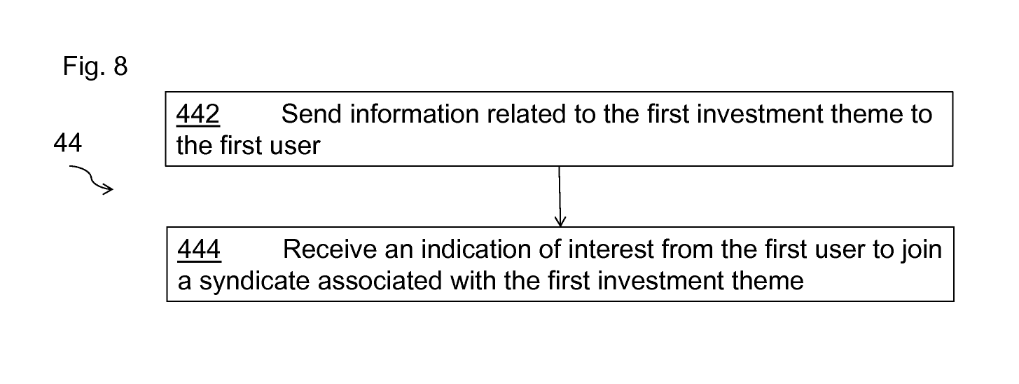

For example, FIG. 8 illustrates an exemplary process of sending syndicate information to a user via the fund management system 10, according to various implementations of the invention.

In an operation 442, the fund management system 10 may send information relating to the investment theme to the first user. The theme determination component 140 may send information to the first user in a manner the same or similar as that described above.

In an operation 444, the fund management system 10 may receive an indication of interest to join the syndicate by the first user. The theme determination component 140 may receive an indication of interest in a manner the same or similar as that described above.

Returning to FIG. 3, in an operation 46, responsive to the first user indicating interest in joining a syndicate for an investment fund related to the investment theme, the fund management system 10 may output to the first user information related to the syndicate and/or other interested users of the syndicate. The theme determination component 140 may output information relating to the syndicate in a manner the same or similar as that described above.

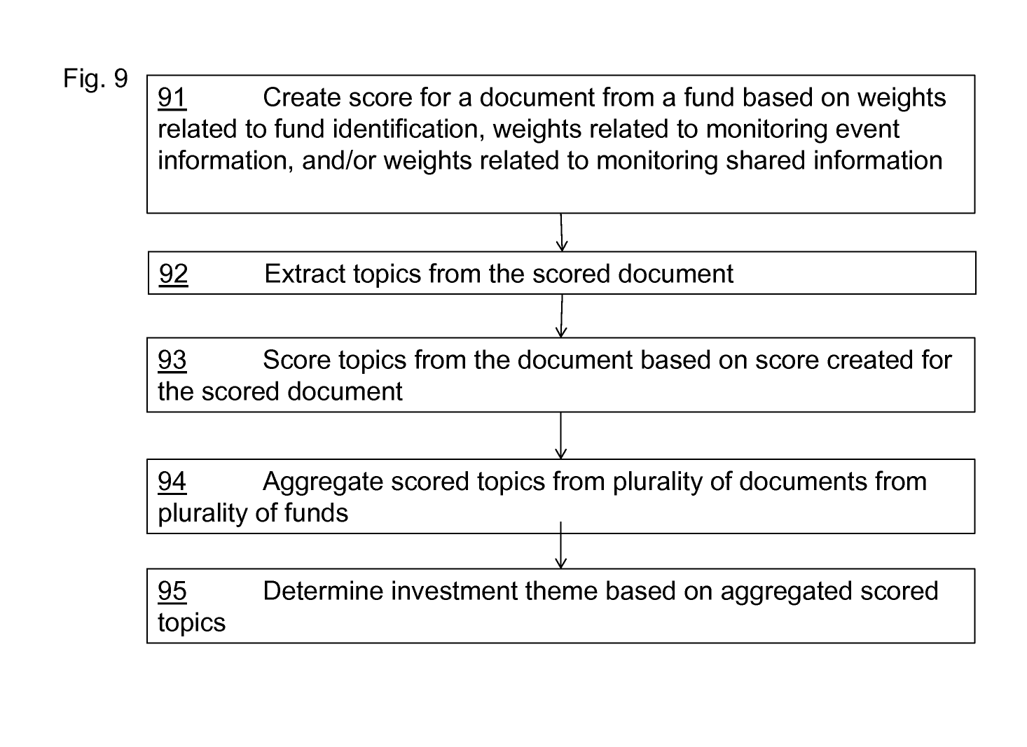

FIG. 9 illustrates an exemplary process of determining an investment theme via the fund management system 10, according to various implementations of the invention.

In an operation 91, the fund management system 10 may create a score for a document based on weights related to fund information, monitoring events information, monitoring shared information, and/or other weights. The theme determination component 140 may determine a score for a document in a manner the same or similar as that described above.

In an operation 92, the fund management system 10 may extract topics from the scored document. The theme determination component 140 may extract topics from the scored document in a manner the same or similar as that described above.

In an operation 93, the fund management system 10 may score topics from the document based on the score determined for the document. The theme determination component 140 may score topics from the scored document in a manner the same or similar as that described above.

In an operation 94, the fund management system 10 may aggregate scored topics from a plurality of scored documents from a plurality of funds managed via the fund management system 10. The theme determination component 140 may aggregate scored topics in a manner the same or similar as that described above.

In an operation 95, the fund management system 10 may determine an investment theme based on the aggregated scored topics. The theme determination component 140 may determine an investment theme based on the aggregated scored topics in a manner the same or similar as that described above.

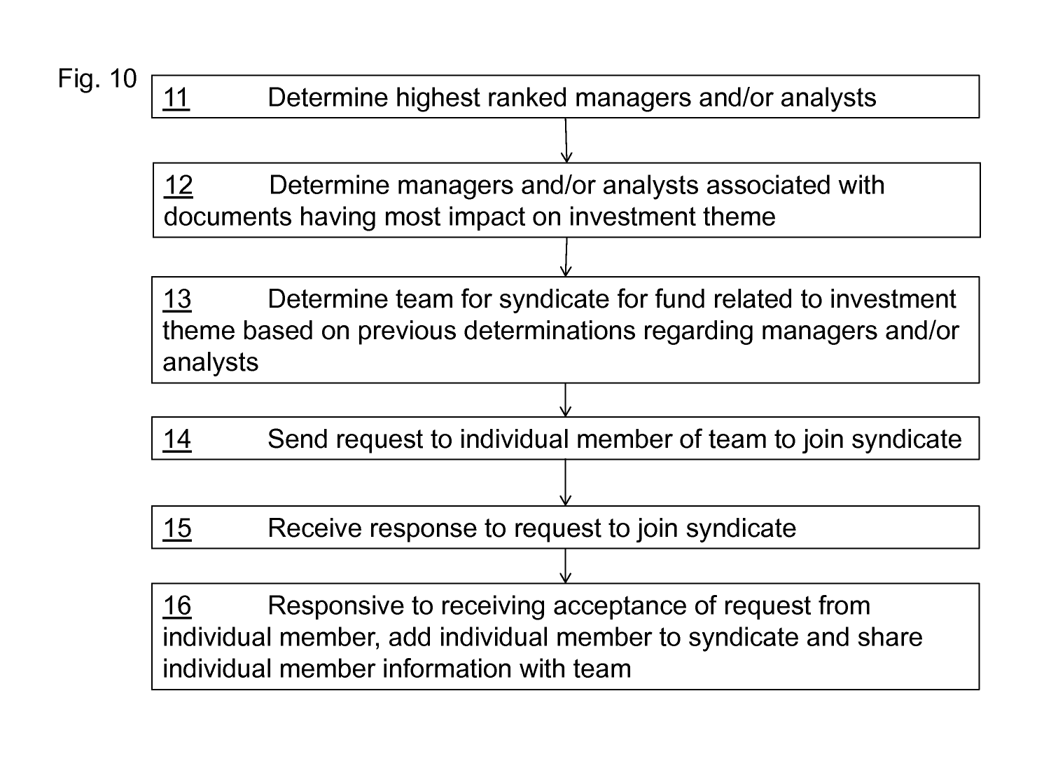

FIG. 10 illustrates an exemplary process of determining a syndicate for an investment fund based on a determined investment theme via the fund management system 10, according to various implementations of the invention.

In an operation 11, the fund management system 10 may determine the highest ranked users of the system. The theme determination component 140 may determine the highest ranked users in a manner the same or similar as that described above.

In an operation 12, the fund management system 10 may determine users associated with documents having the most impact on the determined investment theme. The theme determination component 140 may determine users associated with high impact documents in a manner the same or similar as that described above.

In an operation 13, the fund management system 10 may determine a team for the syndicate based on previous determinations regarding users. The theme determination component 140 may determine a team for the syndicate in a manner the same or similar as that described above.

In an operation 14, the fund management system 10 may send a request to an individual member of the team to join the syndicate. The theme determination component 140 may send the request in a manner the same or similar as that described above.

In an operation 15, the fund management system 10 may receive a response to the request from the individual member. The theme determination component 140 may receive the response in a manner the same or similar as that described above.

In an operation 16, the fund management system 10 may add the individual member to the syndicate and share individual member information with team responsive to individual member accepting the request to join the syndicate. The theme determination component 140 may add the individual member to the team in a manner the same or similar as that described above.

The server 100 may be any computing device such as, for example, a server, a desktop computer, laptop computer, personal digital assistant, smart phone, and/or any other computing device. Other configurations and system architectures may be used. For example, although not shown, server 100 may be or include one or more servers connected to one or more clients via a network 20 such as a Wide Area Network, Local Area Network, the Internet, a cloud-based network and/or other network or combination thereof. The server 100 may be capable of communicating with network 20, non-transitory electronic storage device 200, client devices 300a, 300b, . . . , 300n and/or other computing devices. The server 100 may include a plurality of hardware, software, and/or firmware components operating together to provide the functionality attributed herein to server 100. For example, server 100 may be implemented by a cloud of computing platforms operating together as server 100.

A client device 300n may facilitate communication with the server 100. For example, a user may communicate with the server 100 via a client device 300n. In some implementations, the term user may be interchangeably used herein with the term client device. In some implementations, a user's actions and/or functionality as described herein may be carried out and/or implemented by a client device 300n. A client device 300n may include one or more processors 310n that are configured to execute computer program components. The computer program components may be configured to enable an expert or user associated with the client device 300n to interface with system 10 and/or other components of the system 10, and/or provide other functionality attributed herein to client device 300n. By way of non-limiting example, the client device 300n may include one or more of a desktop computer, a laptop computer, a handheld computer, a tablet computing platform, a NetBook, a Smartphone, a gaming console, and/or other computing platforms. The client device 300n may be capable of communicating with network 20, server 100, non-transitory electronic storage device 200, and/or other computing devices.

The non-transitory electronic storage device 200 may be at least one database that stores system data such as information related to the plurality of funds, information related to the plurality of users, information related to activity performed via the fund management system 10, and/or any other data. The non-transitory electronic storage device 200 may be associated and communicate with the server 100.

The one or more databases comprising the non-transitory electronic storage device 200 may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In some implementations, the non-transitory electronic storage device 200 may be part of or hosted by a computing device on the network 20. In some implementations, the non-transitory electronic storage device 200 may be part of or hosted by the server 100. In some implementations, the non-transitory electronic storage device 200 may be physically separate from the server 100 but may be operably communicable therewith.

In some implementations, the non-transitory electronic storage device 200 may comprise electronic storage media that electronically stores information. The non-transitory electronic storage device 200 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The non-transitory electronic storage device 200 may include one or more virtual storage resources (e.g., cloud storage, a virtual private network, and/or other virtual storage resources). The non-transitory electronic storage device 200 may store software algorithms, information determined by processor 110, information received from server 100, information received from client devices 300a, 300b, . . . 300n, information received from third parties, and/or other information that enables server 100 to function as described herein.

Processor(s) 110 is configured to provide information processing capabilities in computing device 100. As such, processor 110 may include one or more of a digital processor, an analog processor, a digital circuit designed to process information, an analog circuit designed to process information, a state machine, and/or other mechanisms for electronically processing information. Although processor 110 is shown in FIG. 1 as a single entity, this is for illustrative purposes only. In some implementations, processor 110 may include a plurality of processing units. These processing units may be physically located within the same device, or processor 110 may represent processing functionality of a plurality of devices operating in coordination. The processor 110 may be configured to execute components 120, 130, 140, 150, 160, and/or other components. Processor 110 may be configured to execute components 110, 120, 130, 140, 150, 160, and/or components by software; hardware; firmware; some combination of software, hardware, and/or firmware; and/or other mechanisms for configuring processing capabilities on processor 110.

It should be appreciated that although components 120, 130, 140, 150, 160, and/or other components are illustrated in FIG. 1 as being co-located within a single processing unit, in implementations in which processor 101 includes multiple processing units, one or more of components 120, 130, 140, 150, 160, and/or other components may be located remotely from the other components. The description of the functionality provided by the different components 120, 130, 140, 150, 160, and/or other components described below is for illustrative purposes, and is not intended to be limiting, as any of components 1120, 130, 140, 150, 160, and/or other components may provide more or less functionality than is described. For example, one or more of components 120, 130, 140, 150, 160, and/or other components may be eliminated, and some or all of its functionality may be provided by other ones of components 120, 130, 140, 150, 160, and/or other components. As another example, processor 101 may be configured to execute one or more additional components that may perform some or all of the functionality attributed below to one of components 120, 130, 140, 150, 160, and/or other components.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. A computing system for investment fund management configured to anonymously identify users for syndicates for investment themes for new investment funds, comprising:
a memory device;
one or more physical processors programmed with computer readable instructions to:
monitor user activity with respect to one or more documents stored at the memory device;
obtain aggregated information related to investment research activities of a plurality of users based on the monitored user activity;
determine a first investment theme based on the aggregated information;
determine a set of potential users to include in a syndicate for the first investment theme, wherein the first investment theme comprises a topic on which the syndicate may base a strategy for a new investment fund, the set of potential users comprising a first user and a second user from the plurality of users;
cause an invitation to be transmitted to the first user, wherein the invitation invites the first user to accept a membership in the syndicate to be included in the set of potential users;
provide information about the syndicate to the first user;
restrict access by the first user to information related to any members of the syndicate or information related to other users in the set of potential users; and
responsive to the first user indicating acceptance of the membership in the syndicate:
add the first user as a member of the syndicate;
obtain information related to the first user; and
provide the information related to the first user to other members of the syndicate.

2. The computing system of claim 1, wherein the information about the syndicate comprises:
information about the first investment theme; and
information about a role of the first user in the syndicate.

3. The computing system of claim 1, wherein the one or more documents comprise a first set of diligence documents and a second set of diligence documents, and wherein to obtain the aggregated information, the one or more physical processors are programmed with computer readable instructions to:
monitor activity related to the first set of diligence documents and activity related to the second set of diligence documents from the first user;
monitor activity related to the first set of diligence documents and activity related to the second set of diligence documents from the second user;
aggregate the activity from the first user and the activity from the second user;
determine a set of documents from the first set of diligence documents and the second set of diligence documents based on the tracked activity from the first user and the tracked requests from the second user;
extract a set of topics from the set of documents as a first set of potential investment themes; and
determine the first investment theme based on the first set of potential investment themes.

4. The computing system of claim 3, wherein to extract the set of topics, the one or more physical processors are programmed to:
extract a first set of topics from a first document of the set of documents;
determine a first score for a first topic of the aggregated set of topics;
extract a second set of topics from a second document of the set of documents;
determine a second score for a second topic of the aggregated set of topics;
add the first topic with the first score as a first scored topic of the set of topics; and
add the second topic with the second score as a second scored topic of the set of topics.

5. The computing system of claim 1, wherein the one or more physical processors are programmed to:
access information relating to a predetermined number of users of the plurality of users, wherein the predetermined number of users are associated with a predetermined number of highest rankings of users of the system;
determine, for a first high performing user of the subset of users, a list of topics associated with the first high performing user;
determine a relevancy of the list of topics to the investment theme; determine whether the relevancy exceeds or passes a threshold; and
responsive to a determination that the relevancy exceeds or passes the threshold, include the first high performing user in a set of high performing users that are distinguished from other users in the set of users for the syndicate,
wherein the information about the syndicate comprises a number of high performing users in the set of users for the syndicate.

6. The system of claim 1, wherein to select the set of potential users to include in the syndicate the one or more physical processors are further programmed to:
access a ranking of the first user;
determine an impact of a set of documents and a set of funds related to the first user in determining the investment theme;
responsive to the impact being greater than a threshold impact value, include the first user in the set of potential users.

7. The system of claim 6, wherein the one or more physical processors are programmed with computer readable instructions to:
determine a relevance of the first investment theme to the first user based on the determined impact of the set of documents and set of funds related to the first user, wherein the information about the syndicate comprises information related to the relevance of the first investment theme to the first user.

8. The computing system of claim 1, wherein to obtain aggregated information related to investment research activities of a plurality of users based on the monitored user activity, the one or more physical processors are programmed with computer readable instructions to:
extract a set of topics from the one or more documents;
aggregate information related to investment research activities of the plurality of users;
select a subset of the topics as the set of potential investment themes based on a comparison of the aggregated information of the first user and the aggregated information of the plurality of users;
based on the set of potential investment themes, the aggregated information of the first user, and the aggregated information of the plurality of users, identify the first investment theme and the set of potential users to include in the syndicate for the first investment theme.

9. The system of claim 8, wherein the one or more physical processors are programmed with computer readable instructions to:
extract a second set of topics from the aggregated information of the plurality of users;
rank the set of topics based on the comparison of the set of topics and the second set of topics;
select a predetermined number of topics from the set of topics with the highest rankings as the subset of topics;
determine a number of the subset of topics as topics related to the first user;
including the first user in the syndicate responsive to a determination that the number of topics related to the first user exceeds a threshold number.

10. The system of claim 1, wherein the one or more physical processors are programmed with computer readable instructions to:
provide a list of syndicates for which the user is included in a corresponding set of potential users;
rank the list of syndicates based on one or more of: relevance of an individual syndicate to the first user, role of the first user in the individual syndicate, and date of determining the individual syndicate.

11. A method for managing investment funds and anonymously identifying users for syndicates for investment themes for new investment funds, the method being implemented in a computer system comprising a non-transitory electronic storage device and one or more physical processors programmed with computer readable instructions, the method comprising:
monitoring, by the one or more physical processors, user activity with respect to one or more documents stored at the memory device;
obtaining, by the one or more physical processors, aggregated information related to investment research activities of a plurality of users based on the monitored activity;
determining, by the one or physical processors, a first investment theme based on the aggregated information;
determining, by the one or more physical processors, a set of potential users to include in a syndicate for the first investment theme, wherein the first investment theme comprises a topic on which the syndicate may base a strategy for a new investment fund, the set of users comprising a first user and a second user from the plurality of users;
causing, by the one or more physical processors, an invitation to be transmitted to the first user, wherein the invitation invites the first user to accept a membership in the syndicate to be included in the set of potential users;
providing, by the one or more physical processors, information about the syndicate to the first user; and
restricting, by the one or more physical processors, access by the first user to information related to any members of the syndicate or information related to other users in the set of potential users; and
responsive to the first user indicating acceptance of the membership in the syndicate: adding, by the one or more physical processors, the first user as a member of the syndicate;
obtaining, by the one or more physical processors, information related to the first user; and
providing, by the one or more physical processors, the information related to the first user to other members of the syndicate.

12. The method of claim 11, wherein the information about the syndicate comprises:
information about the first investment theme; and
information about a role of the first user in the syndicate.

13. The method of claim 11, wherein the one or more documents comprise a first set of diligence documents and a second set of diligence documents, and wherein obtaining the aggregated information comprises:
monitoring, by the one or more physical processors, activity related to the first set of diligence documents and activity related to the second set of diligence documents from the first user;
monitoring, by the one or more physical processors, activity related to the first set of diligence documents and activity related to the second set of diligence documents from the second user;
aggregating, by the one or more physical processors, the activity from the first user and the activity from the second user;
determining, by the one or more physical processors, a set of documents from the first set of diligence documents and the second set of diligence documents based on the tracked activity from the first user and the tracked requests from the second user;
extracting, by the one or more physical processors, a set of topics from the set of documents as a first set of potential investment themes; and
determining, by the one or more physical processors, the first investment theme based on the first set of potential investment themes.

14. The method of claim 13, wherein extracting the set of topics comprises:
extracting, by the one or more physical processors, a first set of topics from a first document of the set of documents;
determining, by the one or more physical processors, a first score for a first topic of the aggregated set of topics;
extracting, by the one or more physical processors, a second set of topics from a second document of the set of documents;
determining, by the one or more physical processors, a second score for a second topic of the aggregated set of topics;
adding, by the one or more physical processors, the first topic with the first score as a first scored topic of the set of topics; and
adding, by the one or more physical processors, the second topic with the second score as a second scored topic of the set of topics.

15. The method of claim 11, further comprising:
accessing, by the one or more physical processors, information relating to a predetermined number of users of the plurality of users, wherein the predetermined number of users are associated with a predetermined number of highest rankings of users of the system;
determining, by the one or more physical processors, for a first high performing user of the subset of users, a list of topics associated with the first high performing user;
determining, by the one or more physical processors, a relevancy of the list of topics to the investment theme;
determining, by the one or more physical processors, whether the relevancy exceeds or passes a threshold; and
responsive to a determination that the relevancy exceeds or passes the threshold, including, by the one or more physical processors, the first high performing user in a set of high performing users,
wherein the information about the syndicate comprises a number of high performing users in the set of users for the syndicate.

16. The method of claim 11, wherein selecting the set of potential users to include in the syndicate comprises:
accessing, by the one or more physical processors, a ranking of the first user;
determining, by the one or more physical processors, an impact of a set of documents and a set of funds related to the first user in determining the investment theme;
responsive to the impact being greater than a threshold impact value, including, by the one or more physical processors, the first user in the set of potential users.

17. The method of claim 16, further comprising:
determining, by the one or more physical processors, a relevance of the first investment theme to the first user based on the determined impact of the set of documents and set of funds related to the first user,
wherein the information about the syndicate comprises information related to the relevance of the first investment theme to the first user.

18. The method of claim 11, wherein obtaining the aggregated information related to investment research activities of a plurality of users based on the monitored user activity comprises:
extracting, by the one or more physical processors, a set of topics from the one or more documents;
aggregating, by the one or more physical processors, information related to investment research activities of the plurality of users;
selecting, by the one or more physical processors, a subset of the topics as the set of potential investment themes based on a comparison of the aggregated information of the first user and the aggregated information of the plurality of users;
based on the set of potential investment themes, the aggregated information of the first user, and the aggregated information of the plurality of users, identifying, by the one or more physical processors, the first investment theme and the set of potential users to include in the syndicate for the first investment theme.

19. The method of claim 18, further comprising:
extracting, by the one or more physical processors, a second set of topics from the aggregated information of the plurality of users;
ranking, by the one or more physical processors, the set of topics based on the comparison of the set of topics and the second set of topics;
selecting, by the one or more physical processors, a predetermined number of topics from the set of topics with the highest rankings as the subset of topics;
determining, by the one or more physical processors, a number of the subset of topics as topics related to the first user;
including, by the one or more physical processors, the first user in the syndicate responsive to a determination that the number of topics related to the first user exceeds a threshold number.

20. The method of claim 11, further comprising:
providing, by the one or more physical processors, a list of syndicates for which the user is included in a corresponding set of potential users;
ranking, by the one or more physical processors, the list of syndicates based on one or more of: relevance of an individual syndicate to the first user, role of the first user in the individual syndicate, and date of determining the individual syndicate.

21. The computing system of claim 1, wherein to monitor the user activity comprises:
monitor whether a new document has been saved by the user to the memory device to be included among the one or more documents.

22. The computing system of claim 1, wherein to monitor the user activity comprises:
monitor whether a document from among the one or more documents has been accessed by the user through the computing system.

23. The computing system of claim 1, wherein to monitor the user activity comprises:
monitor whether a document has been shared, through the computing system, from one user to at least one other user.

24. The computing system of claim 1, wherein the one or more physical processors are further programmed to:
monitor participation in an event that is accessed through the computing system, wherein the aggregated information is based further on participation in the event.

25. The computing system of claim 24, wherein the one or more physical processors are further programmed to:
identify a topic to which the event relates, wherein the first investment theme is based further on the topic.
